(19) United States
(12) Patent Application Publication
(10) Pub. No.: US 2008/0216329 A1
(43) Pub. Date: Sep. 11, 2008

(54) Ergonomic razor and blade assembly and device for storing and dispensing blade assemblies

(76) Inventor: James M. Leventhal, Newton Center, MA (US)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(21) Appl. No.: 12/023,879

(22) Filed: Jan. 31, 2008

Related U.S. Application Data
(60) Provisional application No. 60/898,764, filed on Jan. 31, 2007.

(51) Int. Cl. B26B 21/52; B26B 21/00; A45D 27/00; B26B 21/44

(52) U.S. Cl. 30/527; 30/526; 30/541

(57) ABSTRACT

A razor includes a handle attached at one end of a blade assembly to position the handle away from the shave path of the razor. The handle and the blade assembly define the razor generally with an L-shape, wherein the handle is positioned in an off set position relative to a center of the blade assembly or away from the shave path. The blade assembly is thereby disposed at a substantially perpendicular orientation relative to the handle. The handle position provides a user of the razor with an unobstructed view of facial and body areas being shaven with the razor. The handle position provides such advantage for both left-handed and right-handed users. The blade assembly of the razor is constructed and arranged to mount one or two razor blade sets along either side of the assembly. In addition, the blade assembly is further constructed and arranged to pivot bi-directionally relative to the handle. A razor cartridge or blade assembly storage and dispensing device in constructed and arranged to house and dispense multiple blade assemblies.

### PRIOR APPLICATION

This application is a nonprovisional patent application claiming priority to U.S. provisional patent application Ser. No. 60/898,764, filed Jan. 31, 2007, the disclosure of which is incorporated herein in its entirety by reference.

### TECHNICAL FIELD OF THE INVENTION

The invention relates to a razor and razor blade assembly for use by men and women. More particularly, the invention provides a razor including a handle configured to provide an end user with improved control of the razor and visibility of areas to be shaven. The invention also relates to a device for storing and dispensing razor blade cartridges and assemblies.

### BACKGROUND OF THE INVENTION

Conventional razors and razor blade assemblies are well known to be effective tools for removing hair from the face, neck, legs, underarms and various other parts of the body. Such hair removal devices generally include straightedge razors and safety razor blade assemblies and cartridges. In addition, such devices typically include a metal razor blade or a series of metal razor blades mounted within an assembly constructed of plastic and/or metal and configured to dispose blades at positions to promote optimal shaving. Numerous blade assemblies are configured to pivot along a vertical axis of a razor in relation to curves of the human body during use of the razor. Blade assemblies or cartridges are typically constructed to attach to a razor handle along a rear center portion of the blade assembly or cartridge. In effect, the handle extends downward from the rear center portion of the assembly or cartridge.

Despite the effectiveness of prior art razors and razor blade assemblies to remove facial and body hair, the challenge remains to improve an end user's control of a razor and/or of a razor blade assembly, during the use of the razor to accomplish better hair removal, while mitigating the risks of cutting facial and body areas during use of the razor. In addition, improving an end user's control of the razor during shaving is a further need to enable an end user to shave with ease and efficiency, while navigating around desired facial hair, such as sideburns, mustache, goatee or beard. Improved control of a razor and/or a razor blade assembly would help to provide an end user with greater control along hairlines and along contours, curves and bumps of facial and body areas being shaven.

As mentioned, many prior art razor and razor blade assembly designs include a handle that extends downward from a rear center portion of a blade assembly. Such handle position often causes an end user's hand to be intrusive during shaving and to visibly obscure facial and body areas being shaven. This often causes shaving to be cumbersome or inefficient because an end user's hand is positioned behind their shave stroke.

In addition, it is well known that where hair and/or shave cream/gel clog one or more blades of a blade assembly, the effectiveness of the razor blades is reduced and shaving is less than optimal. Despite blade assembly designs configured to promote greater water flow, hair and/or shave gel/cream continue to clog blades, especially blades of larger blade assemblies housing a number of blades, that effects shaving quality.

Further, conventional prior art razor and razor blade assembly designs having a handle extending downward from a rear portion of a blade assembly typically require replacement or refill blade cartridges and assemblies to be stored and dispensed from a separate device. Such devices are typically adapted to position and to house blade cartridges or assemblies with the back portions of such cartridges or assemblies exposed. The exposed back portions enable an end user to use the razor handle to mate with and to fasten or clasp to the back portion of a cartridge or assembly such that the end user may use the handle to remove the cartridge or assembly from such device. Blade cartridges and assemblies housed within such storage/dispensing devices are susceptible to steam, water and debris contacting the blades, causing blades to become dull or damaged before use. In addition, blade cartridges or assemblies can fall out of these devices during storage. For these reasons, such storage/dispensing devices make traveling with replacement or refill blade cartridges and assemblies inconvenient and often cumbersome. Prior art razors and razor blade assemblies also typically position a razor blade cartridge or assembly, whether a single blade or a series of blades, along one side of a razor such that when the cartridge or assembly becomes dull or does not produce as good a shave as an end user desires or requires, the cartridge or assembly must be replaced. Refill or replacement cartridges or assemblies therefore must be handy or convenient to the end user, which may not be possible with separate devices for cartridge or assembly storage and dispensing.

### SUMMARY OF THE INVENTION

An object of the invention provides an improved razor and razor blade assembly that attempts to address a number of the shortcomings of prior art designs.

Another object of the invention provides a razor with a handle configured to help to reduce or minimize the intrusiveness of the handle and an end user's hand during shaving to help to increase the end user's visibility of facial and body areas being shaven.

A further object of the invention provides a razor with a blade assembly and a handle that is connected to the blade assembly at an offset position relative to the blade assembly, such that, the blade assembly is disposed at a substantially perpendicular orientation relative to the handle that results in an unobstructed view of the shave path of the razor.

Another object of the invention provides a razor with the offset handle, as described, to provide an unobstructed view of the shave path of the razor for both left-handed and right-handed users of the razor.

A further object of the invention provides a razor with a handle configured to help to provide an end user with control of the razor and its blade assembly to navigate around hairlines, to style or trim desirable body hair, such as sideburns, and to accommodate facial and body shapes and contours.

Yet another object of the invention provides a razor with a blade assembly and a handle whereby the blade assembly is constructed and arranged to pivot bi-directionally in clockwise and counter clockwise directions relative to the handle.

Still another object of the invention provides a razor with a blade assembly constructed and arranged to accept one or more blade sets wherein one blade set is mounted to the blade assembly along one side of the assembly and a second blade set may be mounted to another opposite side of the assembly.

Another object of the invention provides a device configured to store and to dispense replacement blade assemblies according to the invention, as well as to protection blade assemblies during storage and transport.

In general, in an aspect, the invention provides a razor comprising a razor blade assembly configured to mount and to contain one or more razor blades or razor blade cartridges. The razor further includes a handle releasably attached to one end of the razor blade assembly that terminates the length of the razor blade assembly whereby the razor blade assembly is positioned at a substantially perpendicular orientation relative to the handle. The razor blade assembly and the handle thereby define an L-shaped profile. The handle includes a pin projecting from an upper portion of the handle that is constructed and arranged to engage with the razor blade assembly to attach the razor blade assembly to the handle. The blade assembly includes an orifice defined along the one end of the blade assembly. The pin is further constructed and arranged and the orifice is sized and configured such that the orifice receives at least a portion of the pin to attach the handle to the razor blade assembly.

In another aspect, the invention provides a device for storing razor blade cartridges or assemblies comprising a housing defining a chamber and one open terminal end. The housing includes one or more dividing walls. Each dividing wall radiates from a central point of the chamber to an inner surface of the housing and extends downward along at least a portion of the length of the housing. The one or more dividing walls define at least one storage receptacle within the chamber. The storage receptacle has dimensions such that the storage receptacle receives and contains a razor blade cartridge or assembly. The device further includes a spring-loaded cap that is sized and is configured to attach to the open terminal end of the housing. The cap defines an opening along an outer surface. The opening is sized and is configured to permit dispensing of a razor blade cartridge or assembly from the storage receptacle to an area external to the housing.

Implementations of the invention may provide one or more of the following capabilities and/or advantages. A razor may include a handle attached at one end of the razor head or its blade assembly to position the handle away from the shave path of the razor. A razor may include a handle attached at one end of the razor head or its blade assembly to define the razor with an L-shape, wherein the handle is positioned away from the shave path, providing an end user of the razor with an unobstructed view of facial and body areas being shaven with the razor. Such razor may provide greater control of the razor and the blade assembly, as well as greater visibility of the shave path during shaving, in comparison to prior art razor designs. For instance, such razor may provide an end user with greater control in navigating hairlines and in trimming/cutting/styling desirable facial or body hair, such as sideburns or a moustache, goatee or beard. In addition, such razor positions the handle and an end user's hand away from the shave path enabling the end user to have an unobstructed view of areas being shaven. Such razor may provide these capabilities to both left-handed and right-handed users of the razor.

The blade assembly of a razor may be constructed and arranged to permit the blade assembly to pivot in response to pressure or force applied to the blade assembly. Additionally, the blade assembly of a razor may be constructed and arranged to permit the blade assembly to pivot bi-directionally in a clockwise and in a counter clockwise direction relative to the handle in response to such pressure or force. Alternatively, or additionally, the blade assembly may be constructed or arranged to permit the blade assembly to pivot at any one time in either a clockwise direction or a counter clockwise direction relative to the handle. For instance, during shaving with such razor, the blade assembly may pivot in response to pressure or force against the blade assembly or cartridge from contact with a surface to be shaven. Such pivoting of the blade assembly or cartridge may help to accommodate contours, shapes and bumps of facial and body surfaces being shaven to help to minimize risks of razor cuts. In addition, such pivoting of the blade assembly or cartridge may help to provide the end user with greater control and better shaving performance of the razor than prior art designs. A razor may include a blade assembly configured to mount or to contain two razor blade sets. Such razor may include one razor blade set configured for shaving and a second razor blade set configured for trimming/cutting/styling hair, providing greater flexibility in comparison to prior art designs. Further, such razor may include two razor blade sets, each configured for shaving, providing greater flexibility and convenience in comparison to prior art designs.

These and other advantages and/or capabilities of the invention, along with the invention itself, will be more fully understood with a review of the following figures and detail description.

### BRIEF DESCRIPTION OF THE DRAWINGS

FIGS. 1A and 1B are elevational views of a razor according to the invention;

FIGS. 2A and 2B are perspective views of the razor shown in FIGS. 1A and 1B;

FIGS. 3A and 3B are perspective views of a blade assembly and a portion of a handle of the razor shown in FIGS. 1A-1B and FIGS. 2A-2B;

FIG. 4 is a perspective view of the razor shown in FIGS. 1A-3B with the blade assembly detached from the handle;

FIG. 5 is an exploded perspective view of the blade assembly and elements of the handle of the razor shown in FIGS. 1A-4;

FIG. 6 is a cross sectional view of the blade assembly and some of the elements of the handle shown in FIG. 4 in an assembled configuration;

FIG. 7 is a cross sectional view of a portion of the blade assembly and a portion of the handle shown in FIGS. 5 and 6;

FIGS. 8A-8C are end views of the interior of the blade assembly shown in FIGS. 3A-7; and

FIG. 9 is an exploded perspective view of a blade cartridge or assembly storage and dispensing device according to the invention.

### DETAILED DESCRIPTION

The invention provides a razor including a handle and a blade assembly. The handle and the blade assembly are constructed and arranged such that one end of the blade assembly connects to the handle to dispose the handle along the end of the blade assembly and to define the razor with an L-shaped profile. The position of the handle is offset relative to a center of the blade assembly and helps to locate the hand of an end user of the razor away from the shave path of the razor. The handle position thereby helps to provide an end user of the razor with an unobstructed view of the shave path. In addition, the position of the handle further helps to provide an end user of the razor with control of the blade assembly. Further, the offset position of the handle enables a left-handed as well as a right-handed end user to use the razor. The handle further includes a pin or rod and a locking mechanism, each constructed and arranged to permit the handle to be securely and releasably connected to the blade assembly. Alternatively, the handle and the blade assembly may be constructed and arranged to permit the handle to be securely and permanently connected to the blade assembly. The pin or rod is configured and is sized for at least a portion of the pin or rod to be inserted through an orifice of the blade assembly into the interior of the blade assembly. The locking mechanism is configured to retain the portion of the pin or rod in the blade assembly interior until such time the locking mechanism actuates and releases the portion of the pin or rod from the interior of the blade assembly to permit the portion of the pin or rod to be withdrawn. The blade assembly of the razor is constructed and arranged to accept and to mount to the assembly one or more sets of razor blades. Each blade set may include a single razor blade or a series of razor blades with each blade mounted parallel to and spaced from other razor blades of the set. The blade assembly is also constructed and arranged to accept two razor blade sets with each set disposed along either side of the blade assembly. The invention also provides a blade assembly or cartridge storage and dispensing device that is constructed and arranged as an enclosed container for storing multiple blade assemblies and cartridges. The device includes multiple receptacles with each receptacle configured and sized to contain a blade assembly or cartridge. A spring-loaded cap of the device is constructed and arranged to close the device. The cap includes a sealable opening constructed and arranged to permit dispensing of a single blade assembly or cartridge from its receptacle without removing the cap from the device. Other embodiments are within the scope of the invention.

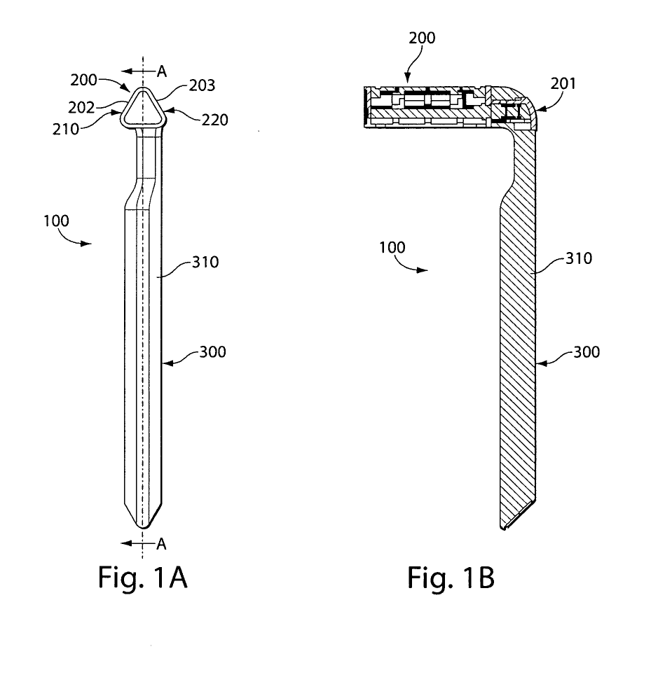

Referring to FIGS. 1A and 1B, in an aspect, the invention provides a razor 100 including a razor blade assembly 200 attached to a handle 300 such that the combination of the assembly 200 and the handle 300 generally define the razor 100 with an L-shape. The handle 300 and the blade assembly 200 are constructed and arranged, as described below in detail, to connect securely and releasably. Where connected, the blade assembly 200 is disposed along its length L₁ at a substantially perpendicular orientation relative to the handle 300. The handle 300 is positioned off set to the center of the blade assembly 200. Where an end user grasps the handle 300, the end user's hand is similarly offset from the center of the blade assembly 200 and thereby removed from the shave path of the blade assembly 200. The orientation of the blade assembly 200 and the handle 300 helps to render the blade path of the blade assembly 200 visible to an end user of the razor 100 during shaving. In addition, the orientation of the blade assembly helps to provide an unobstructed view of the blade path to both left-handed and right-handed end users.

As shown, the handle 300 defines a substantially elongated, e.g., linear, member 310 extending downward from the assembly 200. The invention however is not limited in this respect and envisions that the handle 300 may define other shapes and configurations, and may be of any of a variety of sizes. In other embodiments of the invention, the handle 300 may include a member 30 that defines a curved shape, e.g., an S-shape or a question mark shape.

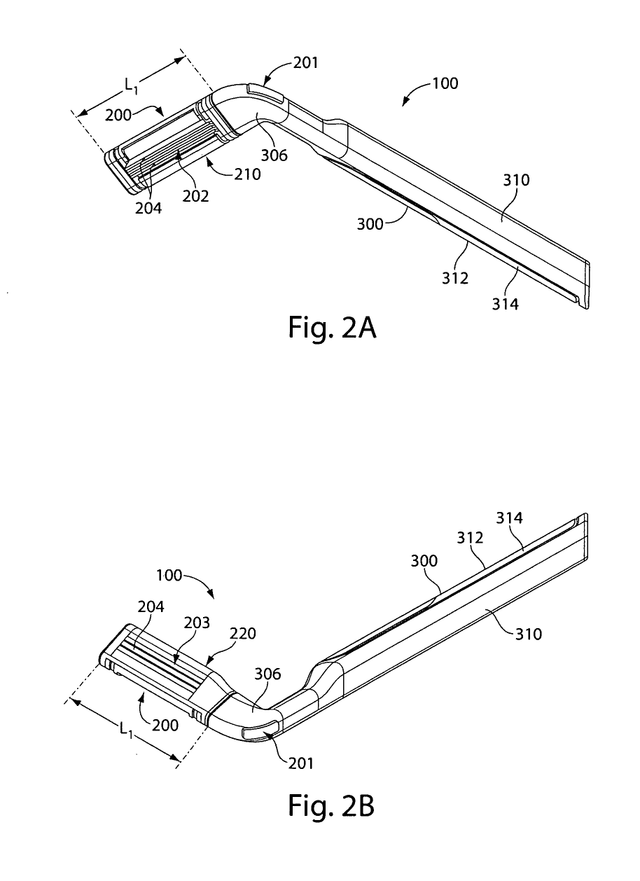

Referring to FIGS. 2A and 2B, and with further reference to FIGS. 1A and 1B, the member 310 of the handle 300 may further include one or more materials 314 and/or one or more surface treatments 314 along at least a portion of its external surface 312. Such material(s) 314 and/or treatment(s) 314 help to promote an end user's grasp or grip of the handle 300 to thereby help to enhance the end user's control of the razor 100 during shaving. In particular, at least a portion of the handle 300 and/or its surface may be constructed of one or more materials 314 and/or one or more treatments 314 to render the handle 300 easy to hold when the handle 300 is wet, dry and/or has disposed thereon soap, shave cream/gel and other shaving products. Well known manufacturing materials and techniques may be employed including, but not limited to, snap-fit materials, two-shot molding techniques and plating processes that coat at least a portion of the handle 300 surface with a soft, easy to hold material.

The blade assembly 200 is configured to accept and to secure two razor blade sets 202 and 203. The blade assembly 200 is configured to accept and to secure a first blade set 202 along a first side 210 of the blade assembly 200 and thereby along a first side of the razor 100. The blade assembly 200 is further configured to accept and to secure a second blade set 203 along a second side 220 of the blade assembly 200 substantially opposite to the first side 210 of the blade assembly 200 and thereby along a second side of the razor 100. Each of the first and the second razor blade sets 202 and 203 includes at least a single razor blade 204 or a series of razor blades 204. Razor blade sets 202 and 203 with a series of razor blades 204 may include two or more blades 204 with each blade 204 mounted to and contained within the set 202 and 203 at a substantially parallel and spaced position relative to other blades 204 mounted to and contained within the set 202 and 203. In some configurations, one of the blade sets 202 and 203 may include a single razor blade 204, e.g., configured for sideburn trimming, while another blade set 202 and 203 may include a series of two or more razor blades 204, e.g., positioned and configured for shaving facial or body hair.

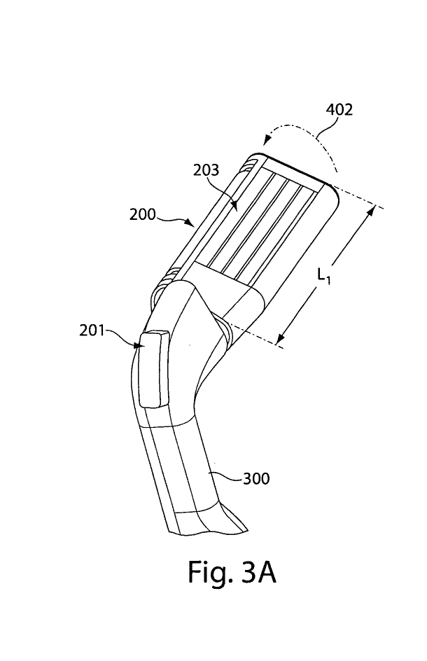

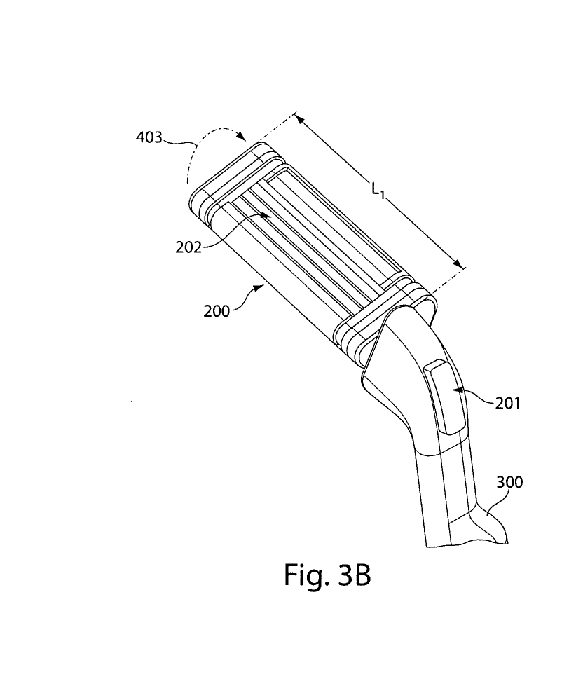

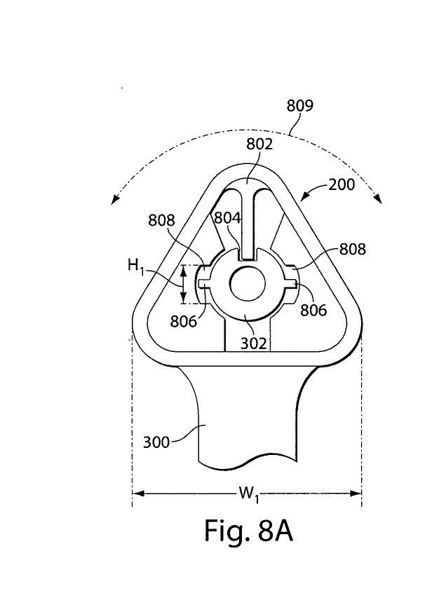

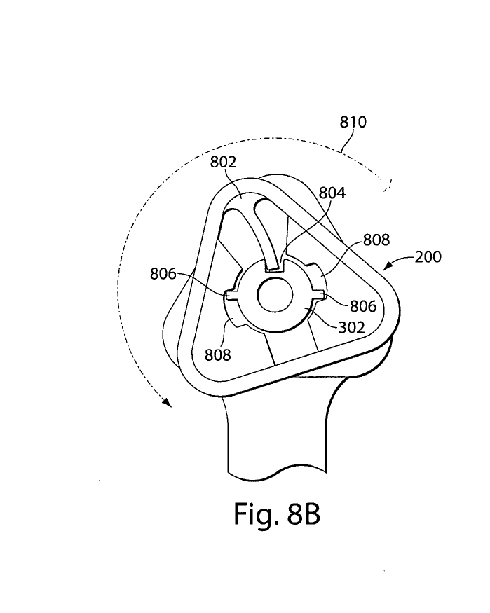

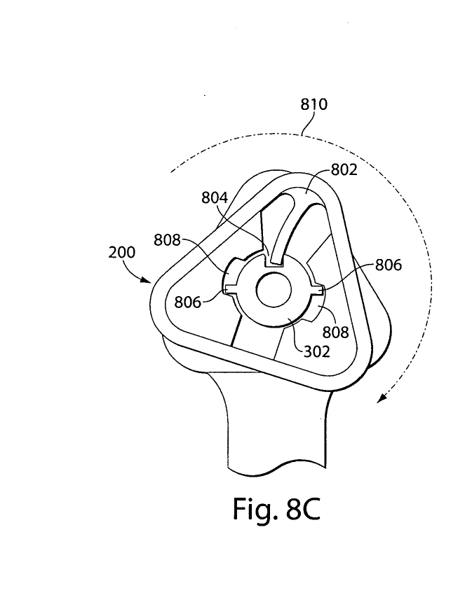

Referring to FIGS. 3A and 3B, and with further reference to FIGS. 2A and 2B, the blade assembly 200 is constructed and arranged to receive and to attach to the handle 300 along one end of the blade assembly 200 such that the blade assembly 200 may pivot relative to the handle 300. As shown in FIGS. 3A and 3B, the handle 300 attaches to one end of the blade assembly 200 that terminates the length L₁ of the blade assembly 300. As described in detail below with reference to FIGS. 8A-8C, the configurations of the blade assembly 200 and the configurations of the handle 300 permit the blade assembly 200 to pivot relative to the handle 300. As shown in FIG. 3A, the blade assembly 200 may pivot about the handle 300 in a counter clockwise orientation or direction, as shown by arrow 402. In addition, as shown in FIG. 3B, the blade assembly 200 may also pivot about the handle 300 in a clockwise orientation or direction, as shown by arrow 403. In one embodiment, the blade assembly 200 may pivot bi-directionally in both clockwise and counter clockwise directions relative to the handle 300 in response to pressure or force applied to the blade sets 202 and 203. Such pressure or force may arise from the contact of the blade sets 202 and 203 to a surface to be shaven and/or the movement of the blade sets 202 and 203 across the surface and its shapes, contours and bumps. Pivoting in response to such pressure or force, the blade sets 202 and 203 accommodate the surface shapes, contours and bumps of an end user's body and may remain in sufficient and/or substantially continuous contact with the surface to help to optimize the razor's 100 performance.

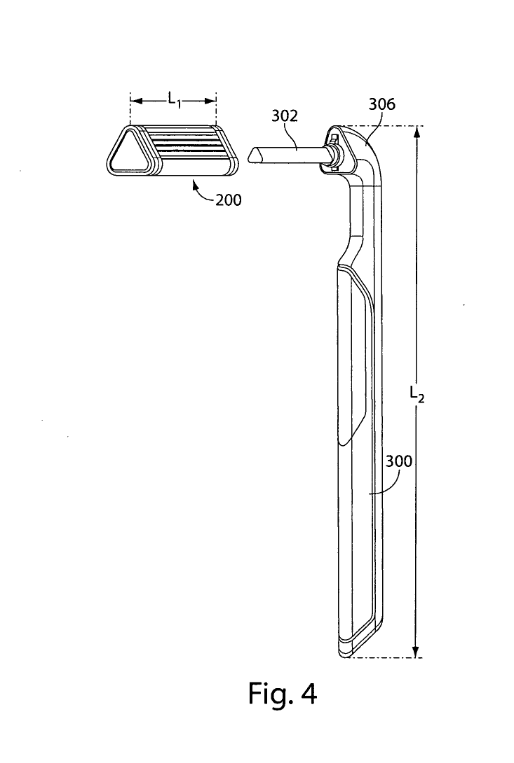

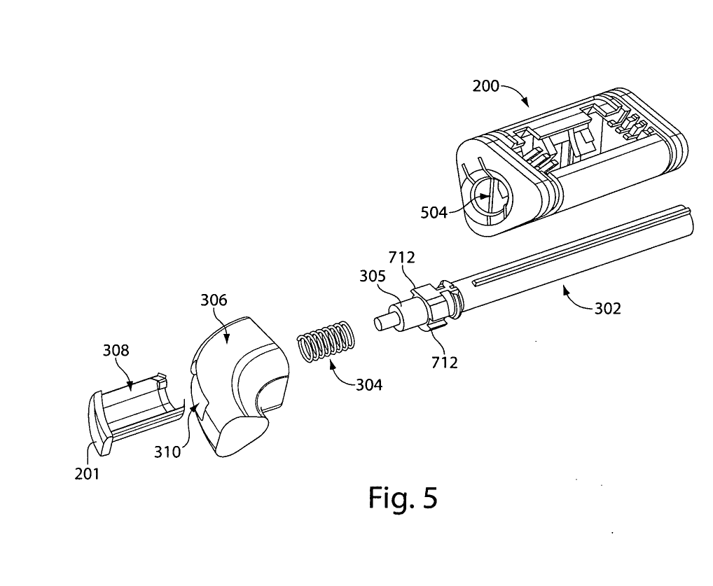

Referring to FIGS. 4 and 5, and with further reference to FIGS. 3A and 3B, the handle 300 is constructed and arranged with an elongate pin or rod 302. The pin or rod 302 is shaped and is sized such that an orifice 504 that the blade assembly 200 defines receives at least a portion of the pin or rod 302. The pin or rod 302 projects from the handle 300 at a substantially perpendicular or sideway orientation relative to the handle 300. Where the orifice 504 of the blade assembly 200 receives at least a portion of the pin or rod 302, the length L₁ of the blade assembly 200 is positioned at a substantially perpendicular or sideway orientation relative to the length L₂ of the handle 300. When an end user grasps the handle 300 and pulls the handle 300 in a downward or an upward direction, or in a transverse or sideway direction, e.g., across a surface to be shaven, the one or more blades of the blade set 202 and 203 similarly move, e.g., along the surface, in the same downward or upward direction or the transverse or sideway direction. The blade assembly 200 thereby substantially follows the direction in which the handle 300 moves. The handle 300 is disposed away from the path of the one or more blades 204 to help to minimize or prevent the handle 300 and/or the end user's hand from visually blocking the blade path. An end user grasping the handle 300 can view the blade path during shaving which helps to enhance the end user's control of the razor and shaving performance.

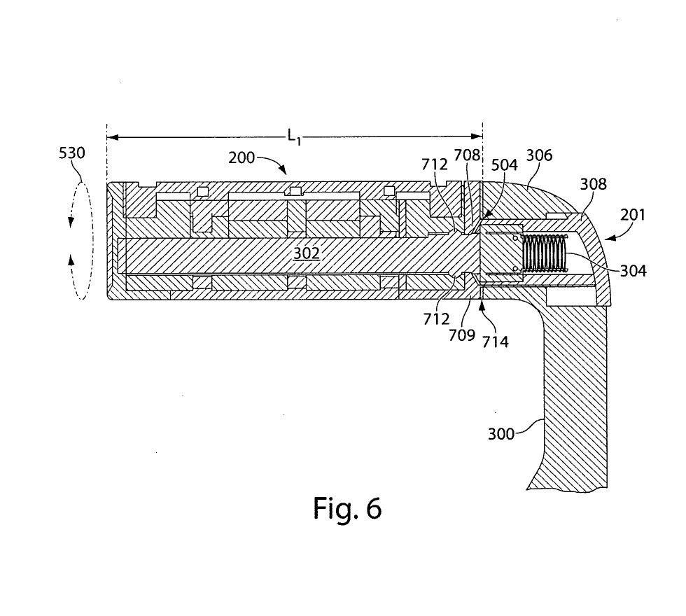

Referring to FIG. 6, and with further reference to FIGS. 4 and 5, the pin or rod 302 and the orifice 504 are further constructed and arranged such that the orifice 504 receives at least a portion of the pin or rod 302 to dispose the portion of the pin or rod 302 within the interior of the blade assembly 202 and 203. Portions of the interior configuration of the blade assembly 200 and portions of the pin or rod 302 are configured and are sized to help such portions to engage with one another in order the blade assembly 200 and the handle 300 connect securely and releasably. As described below with reference to FIGS. 8A-8C, additional portions of the interior configuration of the blade assembly 200 and of the pin or rod 302 are configured and are sized to help to permit the blade sets 202 and 203 to pivot in one direction and/or bi-directionally, as described above.

In one embodiment, the pin or rod 302 is constructed with at least one locking notch 712 that is disposed and is configured to engage with at least one locking tab 708 or 709 defined along the interior configuration of the blade assembly 200. The locking tab 708 or 709 is disposed and is configured such that the locking tab 708 or 709 resides proximate to or in contact with the locking notch 712 where at least a portion of the pin or rod 302 is received by the orifice 504. The position of the locking tab 708 or 709 relative to the locking notch 712, or the contact of the locking tab 708 or 709 with the locking notch 712, help to securely and releasably engage or connect the pin or rod 302 to the interior configuration of the blade assembly 200 to thereby securely and releasably connect the blade assembly 200 to the handle 300.

As shown in FIG. 6, in one embodiment, the pin or rod 302 includes two locking notches 712 along opposite sides of the pin or rod 302 that are positioned in substantial alignment with one another. In such embodiment, the interior configuration of the blade assembly 200 defines two locking tabs 708 and 709 along opposite walls of the interior configuration and in substantial alignment with one another. The location of the locking tabs 708 and 709 relative to the locking notches 712 along the pin or rod 302 permit the locking tabs 708 and 709 to be positioned proximate to or in contact with the locking notches 712. As shown in FIG. 6, the locking notches 712 are positioned anterior to the locking tabs 708 and 709 relative to the orifice 504, where at least a portion of the pin or rod 302 is disposed within the interior configuration of the blade assembly 200. The positions of the locking tabs 708 and 709 and the locking notches 712 relative to one another help to immobilize the portion of the pin or rod 302 within the interior configuration and help to securely and releasably engage or connect the blade assembly 200 with the handle 300.

With further reference to FIGS. 5 and 6, the handle 300 further includes a locking mechanism comprising a spring 304, an actuator 308 member, and an actuator button 201. Collectively these elements help to load at least a portion of the pin or rod 302 through the orifice 504 and into the interior configuration of the blade assembly 200, and further help to immobilize the portion of the pin or rod 302 residing within the interior configuration. As shown in FIG. 6, where the spring 304, actuator member 308 and pin or rod 302 are assembled, the positions of the locking tabs 708 and 709 help to prevent movement of the locking notches 712 within the interior configuration of the blade assembly 200. In particular, the position of the locking tabs 708 and 709 help to prevent movement of the locking notches 712 toward the orifice 504. In this manner, the locking tabs 708 and 709 help to immobilize the portion of the pin or rod 302 residing within the interior configuration such that the portion of the pin or rod 302 is in a locked portion, as shown in FIG. 6.

The actuator member 308, as shown in FIG. 5, includes an actuator button 201. The actuator member 308 is configured and is sized such that the orifice 504 receives at least a portion of the actuator member 308 to dispose the portion of the actuator member 308 through the orifice 504 and within the interior configuration of the blade assembly 200. Terminal ends of the actuator member 308 are thereby disposed proximate to or in contact with the locking tabs 708 and 709. In one embodiment, the actuator member 308 is sized and is configured as a curved plane, as shown in FIG. 5, to complement or to accommodate the cross-section of the orifice 504 and/or the interior configuration of the blade assembly 200.

The spring 304 connects with or slides over a terminal portion 305 of the pin or rod 302 adjacent to the locking notches 712. In one embodiment, the spring 304 slides over the terminal portion 305 behind or posterior to the locking notches 712 relative to the handle 300 when the razor 100 is assembled. In one embodiment, the actuator member 308 is sized and is configured, as mentioned, to complement or to accommodate the cross-section of the orifice 504 such that the interior configuration of the blade assembly 200 receives at least a portion of the member 308. In addition, in such embodiment, the actuator member 308 is sized and is configured to extend over and/or around the spring 304.

The handle 300 may include a casing or housing 306. The casing or housing 306 is constructed and arranged such that its interior configuration helps to receive and to position at least a portion of the actuator member 308, and helps to effect assembly of the member 308 over the spring 304 and the spring 304 over the terminal portion 305 of the pin or rod 302. As shown in FIG. 6, when assembled over the spring 304, at least a portion of the actuator member 308 may extend through the orifice 504 into the interior configuration of the blade assembly 200.

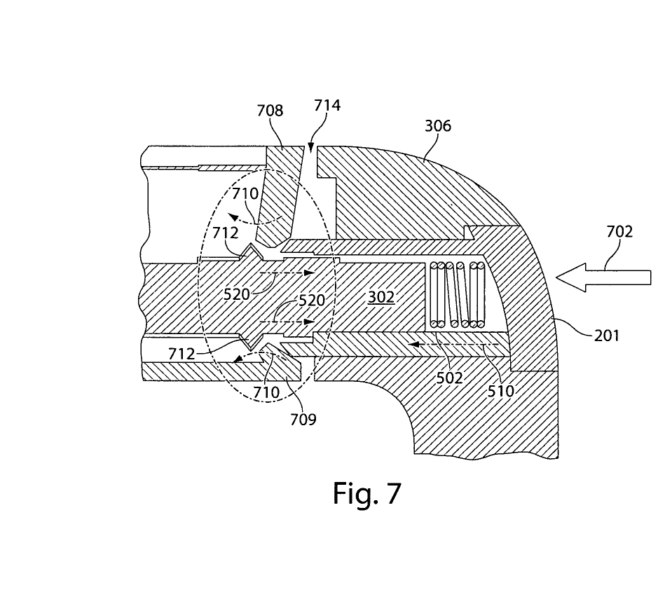

Referring to FIG. 7, and with further reference to FIGS. 5 and 6, where at least a portion of the pin or rod 302 is disposed through the orifice 504 and within the interior configuration of the blade assembly 200, the locking notches 712 are positioned proximate to or in contact with the locking tabs 708 and 709 as described above. The locking tabs 708 and 709 help to prevent the pin or rod 302 from sliding back and forth along the interior configuration of the blade assembly 200 and through the orifice 504, which essentially helps to immobilize the pin or rod 302 residing in the interior configuration and locks the pin or rod 302 in place. The actuator button 201 and the actuator member 308 are constructed and arranged to actuate the pin or rod 302 from a locked position to an unlocked position.

As mentioned, the actuator member 308 is connected to the actuator button 201. The actuator button 201 is disposed and is configured such that at least a portion of the actuator button 201 is exposed along the exterior surface of the casing or housing 306. Where at least a portion of the actuator member 308 is contained or housed by the casing or housing 306, at least a portion of the actuator button 201 is accessible from an area external to the case or housing 306. The actuator button 201 is disposed along the casing or housing 306 at a position that helps to enable an end user's hand and/or fingers to access and to actuate the button 201, e.g., when the end user grasps the handle 300, to release the pin or rod 302 from the locked position to an unlocked position, as shown in FIG. 7.

Where the actuator button 201 is forced inward, depressed or otherwise actuated, e.g., in response to pressure or force 702 applied to the actuator button 201, the spring 304 compresses, e.g., in a direction shown by arrow 510. Because of compression of the spring 304, the actuator member 308 moves further through the orifice 504. In one embodiment, at least a portion of the actuator member 308 moves further through the orifice 504 and thereby into the interior configuration of the blade assembly 200 at least to the extent a portion of the actuator member 308 contacts and presses against and/or passes by one or both of the locking tabs 708 and 709. The movement of the portion of the actuator member 309 against and/or past the locking tabs 708 and 709 causes the locking tabs 708 and 709 to bias or to deflect, e.g., inward or away from the orifice 504, in response. In one embodiment, the locking tabs 708 and 709 bias or deflect in the direction shown by arrow 710 in FIG. 7. Such movement or displacement of the locking tabs 708 and 709 helps to permit the pin or rod 302 to move within the interior configuration of the blade assembly 200, and helps to permit the pin or rod 302 to be withdrawn from the blade assembly 200 to disconnect or detach the blade assembly 200 from the handle 300.

As shown in FIG. 7, the locking tabs 708 and 709 bias or deflect to the extent that sufficient clearance is produced between the locking notches 712 and the locking tabs 708 and 709. Such clearance helps to permit the locking notches 712 to move in direction 520 and to slide past the locking tabs 708 and 709 and move toward the orifice 504 in the direction shown by arrow 520 in FIG. 7. As the locking notches 10 slide past the locking tabs 708 and 709, the pin or rod 302 can be withdrawn from the interior configuration of the blade assembly 200 and through the orifice 504. In this manner, an end user of the razor 100 may slidably remove the pin or rod 302 from the interior configuration of the blade assembly 20, while depressing or otherwise actuating the actuator button 201 to help to disconnect or detach the blade assembly 200 from the handle 300.

The locking notches 712 and the locking tabs 708 and 709 are configured and are disposed to help to securely and releasably connect and lock the blade assembly 200 to the handle 300. The positions of the locking notches 712 and the locking tabs 708 and 709 remain in the locked position, as shown in and described with reference to FIG. 6, until such time as the actuator member 308 01 is actuated, e.g., moves further through the orifice 504, to change the positions of the locking tabs 708 and 709 relative to the locking notches 712. Changing the positions of the locking tabs 708 and 709 relative to the locking notches 712 results in the unlocked position, as shown in and described with reference to FIG. 7. In the unlocked position, the locking tabs 708 and 709 deflect and provide sufficient clearance to permit the locking notches 712 to slide past or move by the locking tabs 708 and 709 in order to withdraw the portion of the pin or rod 302 residing within the interior configuration of the blade assembly 200. In one embodiment, actuating the actuator button 201 causes the actuator member 308 to move further through the orifice 504 and a portion of the actuator member 308 to contact and push against the locking tabs 708 and 709. This causes the locking tabs 708 and 709 to deflect or move away from the locking notches 712 to permit the pin or rod 302 to be removed from the interior configuration of the blade assembly 200 to detach the blade assembly 200 from the handle 300.

The construction and the arrangement of the pin or rod 302, the actuator member 308 and actuator button 201, and the spring 304 collectively help to reduce the number of components, parts, configurations or other elements required to help to achieve a secure and releasable locking engagement or connection of the blade assembly 200 with the handle 300. As the pin or rod 302, the actuator member 308 and the spring 304 are contained or housed within the casing or housing 306, when assembled with one another, these elements are relatively unexposed. During connection and detachment of the handle 300 from the blade assembly 200, and during use of the razor 100, opportunities or risks of damage to any of such elements are minimized or eliminated.

In alternate embodiments of the invention, the pin or rod 302, the actuator member 308 and the spring 304 reside within the interior configuration of the blade assembly 200. The pin or rod 302 projects at sufficient length from the blade assembly 200 such that an orifice 504 along the handle 300 receives at least a portion of the pin or rod 302. Essentially, the positions and locations of the elements described above with reference to FIGS. 4-7 are reversed. Those elements attached to, defined in or integral to the handle 300, e.g., the pin or rod 302, the actuator member with or without the actuator button 201 and the spring 304 reside within at least a portion of the interior configuration of the blade assembly 200. The handle 300 defines the orifice 504 and an interior configuration of a portion of the handle 300 defines the elements, e.g., the locking tabs 708 and 709, previously described as of the interior configuration of the blade assembly 200.

Referring to FIGS. 8A-8C, and with further reference to FIG. 7, the construction and the arrangement of the pin or rod 302, the actuator member 308 and/or the spring 308, and the configuration and size of the orifice 504 may be further adapted to help to permit the blade assembly 200 to pivot when the blade assembly 200 and the handle 300 are attached. Where the blade assembly 200 connects to the handle 300, the assembly 200 may pivot slightly about an axis, e.g., a central axis, of the interior configuration of the blade assembly 200 along the length L₁ of the blade assembly 200. The blade assembly 200 may pivot slightly about a point of attachment or an interface 714 of the blade assembly 200 and the orifice 504 with the casing or housing 306 of the handle 300 in response to application of pressure or force to the blade assembly 200. For instance, application of pressure or force to a surface of either blade sets 202 and 203, e.g., one or more edges of one or more blades 204, would cause the blade assembly 200 to pivot slightly about the attachment point or the interface 714. In this manner, when the surface of one of the blade sets 200 contacts an end user's body surface, e.g., face, and the end user applies pressure or force to the blade set 202 and 203 during use of the razor 100, the blade assembly 200 pivots slightly about the attachment point or the interface 714 in response to such pressure or force. The blade assembly 200 thereby accommodates any pressure or force applied to the surface of the blade set 202 and 203 as a result of the surface of the blade set 202 and 203 moving across a surface, e.g., an end user's body surface. The pivoting blade assembly 200 helps the razor 100 to conform to or to accommodate any facial and body shapes, contours or bumps to help to enhance the control and the shaving performance of the razor 100.

In one embodiment of the invention, the interior configuration of the blade assembly 200 is further adapted and includes elements to help to permit the blade assembly 200 to pivot slightly in a counter clockwise or clockwise direction 403 and 404, as described above with reference to FIGS. 3A and 3B and FIG. 7.

In another embodiment of the invention shown in FIGS. 8A-8C, the interior configuration of the blade assembly 200 is adapted and includes elements to help to permit the blade assembly 200 to pivot slightly in both clockwise and counter clockwise directions 403 and 404 or to pivot bi-directionally relative to the handle 300, as shown by arrow 809 in FIG. 8A. The interior configuration of the blade assembly 200 and the configuration of the pin or rod 302 help to permit the blade assembly 200 to pivot within a certain range of movement to enable the blade assembly 200 to respond to pressure or force applied along the surface of the blade set 202 and 203. The pin or rod 302 is further configured to define along at least a portion of its length a slot or notch 804 sized and configured to receive at least a portion of a pivot finger 802. Surfaces of the interior configuration of the blade assembly 200 define the pivot finger 804. The pivot finger 803 extends or projects from such surfaces. As shown in FIG. 8A, the slot or notch 804 and the pivot finger 802 are sized and configured such that where the slot or notch 804 receives at least a portion of the pivot finger 802, the pivot finger 802 helps to resist or inhibit pivoting movement of the blade assembly 300. In one embodiment, a top portion of the interior configuration of the blade assembly 200 defines the pivot finger 804 and the pivot finger 804 extends downward. In this case, a top portion of the pin or rod 302 defines the slot or notch 804 to receive at least a portion of the pivot finger 802.

The pin or rod 302 further includes at least two pivot rod locks 806 defined in opposite sides of the rod or pin 302 and in substantial alignment with one another. The pin or rod 302 defines each pivot rod lock 806 at about a 90-degree angle relative to the slot or notch 804.

The interior configuration of the blade assembly 200 further defines along at least a portion of one of its surfaces a lock opening or depression 808 disposed at a location along the interior configuration and having a depth to receive at least a portion of one of the pivot rod locks 806. The lock depression 808 further has a specific height H₁ that helps to permit the pivot rod lock 806 to move upward and downward within the lock depression 808 when the pin or rod 302 pivots, as shown by arrow 810 in FIGS. 8B and 8C. In one embodiment, the interior configuration of the blade assembly 200 defines two lock depressions 808 disposed opposite to and in alignment with one another along the interior configuration of the blade assembly 200. As mentioned, the lock depressions 808 are located along a portion of the interior configuration such that each lock depression 808 receives at least a portion of a pivot rod lock 806.

As shown in FIGS. 8B and 8C, where a surface of either of the blade sets 202 and 203 contacts a surface to be shaven and/or moves across such surface, in response to any pressure or force to the surface of the blade set 202 and 203 resulting from such contact and/or movement, the blade assembly 200 pivots. The deflection of the pivot finger 802 within its slot or notch 804 permits the blade assembly 200 to pivot. The pivot finger 802 is constructed of one or more materials that provide the pivot finger 802 with sufficient deflection ability such that the pivot finger 802 may deflect to a required or desired angle or extent that permits the blade assembly 300 to pivot.

The extent to which the blade assembly 300 pivots bi-directionally, as shown by arrow 809, or pivots either in a counter clockwise or clockwise direction, as shown by arrow 810 in FIGS. 8B and 8C, is affected by the pivot rod locks 806 and the lock depressions 808. In other words, the range of movement of the blade assembly 300 relative to the handle 300 is affected by the locks 806 and lock depressions 808. The portion of each pivot rod lock 806 that the lock depression 808 receives moves upward and downward along the height HI of the lock depression 808 until it reaches one end of the depression 808 or a maximum of a range of movement of the blade assembly 300. As shown in FIG. 8B, the blade assembly 300 is permitted to pivot in a counter clockwise direction 810 until each pivot rod lock 806 reaches an end of the lock depression 808, or, in other words, reaches the top or the bottom of the lock depression 808,. Where the pivot rod lock 806 no longer moves within the lock depression 808, the blade assembly 200 has reached a maximum of its range of movement. In this manner, the height HI of the lock depressions 808 helps to define the range of movement of the blade assembly 200 in response to any force or pressure applied to either of the blade sets 202 and 203.

Where the pivot rod locks 806 have reached either the top or bottom of their respective lock depressions 808, tension builds within the blade assembly 200 due to the deflection of the pivot finger 802. The tension produced by the deflected pivot finger 802 is sufficient such that where the surface of the blade set 202 and 203 is removed from a surface, and/or a pressure or force is no longer applied to the blade set 202 and 203 surface, the pivot finger 802 returns to its unbiased or non-deflected position. The consequent release of tension helps to create a spring-like action of the blade assembly 200. The spring-like action helps to return the blade assembly 200 to its original position.

The razor 100 is constructed or one or more materials suitable for use of the razor 100 in wet and/or damp environments and with any of a variety of grooming products such as, but not limited to, soap, shave gel/cream, and skin moisturizers. In addition, one or more materials of construction of the razor 100 include one or more materials suitable to provide resilience to wear and tear of the razor 100 through its use and transport, and to enable the razor 100 to be relatively lightweight to ensure ease of use and transport. Certain components of the razor 100 including, but not limited to, the pin or rod 302, the locking notches 712, the locking tabs 708 and 709, and the pivot finger 802 may be constructed of one or more materials that enable such components to deflect, and/or to bend, in response to an application of pressure or force to such component. Such materials of construction include, but are not limited to, metal, metal alloys, plastic, ABS, polymers, synthetic rubber, polypropylene, other flexible materials, wood, ceramic, glass, and any combinations thereof.

Other features or embodiments of the razor 100 are within the scope of the invention. For example, the blade assembly 200 may be constructed and arranged to receive and to mount a single blade set 202 or 203 along one side of the assembly 200. As another example, the blade assembly 200 may be further constructed and arranged to pivot bi-directionally in both clockwise and counter clockwise directions relative to the handle 300 and to pivot in one of a clockwise or counter clockwise direction. In this case, the blade assembly 200 would be further configured with a lock mechanism that would adjust the pivoting ability of the assembly 200 to permit bi-direction pivoting and pivoting in only one of the clockwise or counter clockwise. As a further example, the blade assembly 200 and the handle 300 may be constructed and arranged to attach permanently to the blade assembly 200 for a disposable version of the razor 100. Where the one or more blades 204 of the one or more blade sets 202 and 203 no longer effectively shave facial and/or body hair, the razor 100 may be disposed. As another example, the handle 103 may be further constructed and arranged to define within its interior a chamber configured and sized to accommodate a power source and associated components operatively coupled with the power source that would cause the handle 300 and the blade assembly 200 to vibrate. The power source may include, but is not limited to, one or more batteries, such as disposable or rechargeable batteries, and a motor with a switch, wiring and associated components. Still another example, the handle 300 may be further constructed and arranged to define within its interior a chamber configured and sized to accommodate one or more light-emitting elements, wherein the light-emitting elements may include, but are not limited to, one or more light-emitting diodes (LEDs), light bulbs, fluorescents, solar cells, and other lighting devices. The chamber would further accommodate any electronic/electrical components and circuitry to operate the one or more light-emitting elements. The handle 300 may be further configured along its surface with one or more areas or portions constructed of one or more translucent or transparent materials that would permit light produced by the light-emitting elements to transmit or reflect through the translucent or transparent areas or portions to an area external to the handle 300. In addition, the blade assembly 200 may be further configured along its surface with one or more areas or portions constructed of one or more translucent or transparent materials that would permit light that the light-emitting elements generate to transmit or reflect through such translucent or transparent areas or portions to an area external to the blade assembly 200.

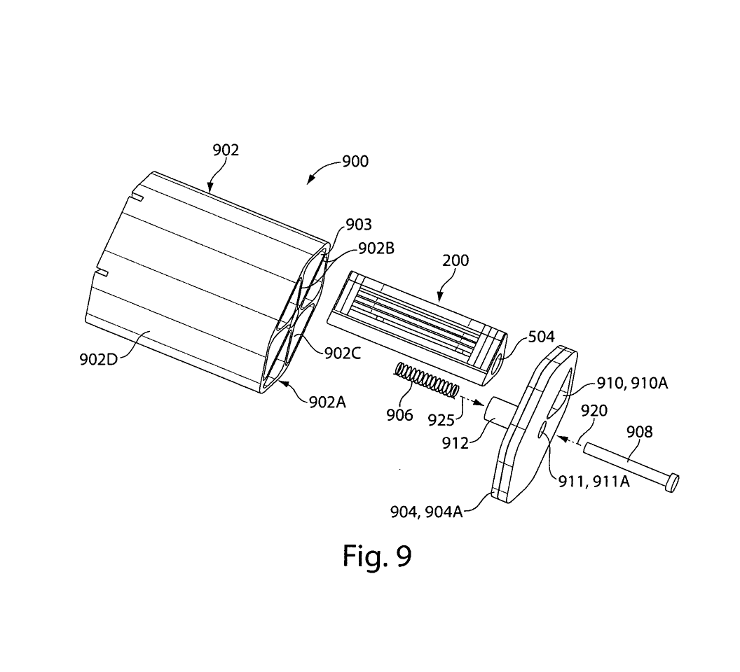

Referring to FIG. 9, in another aspect, the invention provides a razor blade cartridge storage and dispensing device 900. In addition to storing and dispensing new blade cartridges, the device 900 may dispense new blade assemblies 200 according to the invention as described above, and may be further used to stored used cartridges and used blade assemblies 200. The device 900 includes a housing 902 configured to hold one or more razor blade sets, a cap 904 and a lower cap 904A, each configured to connect to one end 902A, e.g., a terminal end, of the housing 902, and a screw and spring 906 and 908 combination that helps to movably attach the cap 904 to the lower cap 904A and both caps 904 and 904A to the housing 902. As described below, the screw and spring 906 and 908 combination permits the caps 904 and 904A to rotate relative to one another. The caps 904 and 904A are configured and are sized to close-off and seal the end 902A of the housing 902. The cap 904 is further configured with an opening 910. The opening 910 is shaped and is sized to permit a blade cartridge or assembly contained within the housing 902 to be dispensed through the opening 910 from the interior of the housing 902 to an area exterior to the housing 902.

The lower cap 904A and a circumference of the end 902A of the housing 902 are constructed and arranged such that the lower cap 902A mates to the circumference of the end 902A to attach the lower cap 904A to the housing 902. The lower cap 904A and the circumference of the end 902A are configured to permit the lower cap 904A to move along the circumference of the 902A to enable the lower cap 904A to rotate about the end 902A.

The lower cap 904A is further constructed and arranged to mate with the cap 904. As shown in FIG. 9, the lower cap 904A has substantially the same shape and dimensions as the cap 904 such that both the cap 904 and the lower cap 904A may close-off the end 902A of the housing 902. The lower cap 904A is further configured with an opening 910A. The opening 910A is shaped and is sized to permit a blade cartridge or assembly contained within the housing 902 to be dispensed through the opening 910 from the interior of the housing 902 to an area exterior to the housing 902.

The lower cap 904A further includes a rod 912 that extends from a lower surface of the cap 904A and from an opening 91 1A defined through the lower cap 904A. The rod 912 is constructed and is arranged as a cylinder, and is sized and is configured to receive at least a portion of the screw 908. The cap 904 similarly includes an opening 911 defined through the cap 904. Where the cap 904 and the lower cap 904A are mated, the openings 911 and 911A align with one another to define an opening through both caps 904 and 904A. The openings 911 and 911A are sized and are configured to receive at least a portion of the screw 908. Where the caps 904 and 904A are mated and the openings 911 and 911A are aligned, the screw 908 may pass through the openings 911 and 911A and into the rod 912. In addition, the rod 912 is sized and is configured to receive the spring 906. Where the screw 908 is inserted through the openings 911 and 911A of the caps 904 and 904A, as shown by arrow 920 in FIG. 9, the spring 906 may be inserted through the rod 912 at an end of the rod 912 opposite to the opening 911A, as shown by arrow 925 in FIG. 9. The spring 906 thereby receives at least a portion of the screw 908, or, in other words, slides telescopically over the portion of the screw 908, to couple the spring 906 and the screw 908.

Where the caps 904 and 904A are mated and the spring 906 and the screw 908 are coupled, the caps 904 and 904A are assembled and may be affixed to the end 902A of the housing 902. The spring 906 and screw 908 combination permits the caps 904 and 904A to rotate relative to one another, and permits the lower cap 904A to rotate or move along the circumference of the end 902A of the housing 902. The housing 902 is configured and is sized to hold multiple blade cartridges and assemblies. The housing 902 includes walls 902D that define an inner chamber 902C. The area of the inner chamber 902C is defined by one or more dividing walls 902B that extend along the length L₂ of the housing 902 to define one or more storage receptacles 903 within the housing 902. Each storage receptacle 903 has overall dimensions such that the receptacle 903 receives and contains a blade cartridge or assembly. Where the caps 904 and 904A are attached to the housing 902, each receptacle 903 is defined as a closed receptacle 903. The closed receptacle 903 houses a blade cartridge or assembly until the blade cartridge or assembly is dispensed from the device 900.

To dispense a blade cartridge or assembly from the housing 902, the lower cap 904A is rotated until the opening 910A aligns with an opening to one of the receptacles 903. The lower cap 904A rotates about or moves along the circumference of the end 902A of the housing 902. The cap 904 is rotated relative to the lower cap 904A to the extent the opening 910 aligns with the opening 910A of the lower cap 904A. Alignment of the openings 910 and 910A with the opening of the receptacle 903 permits a blade cartridge or assembly residing in the receptacle 903 to pass through the openings 910 and 910A and to dispense from the device 900.

Where the caps 904 and 904A are assembled with the spring 906 and the screw 908, and the assembled caps 904 and 904A are affixed to the end 902A of the housing 902, the spring 906 and the screw 908 help to create sufficient tension to prevent the caps 904 and 904A from moving relative to one another and help prevent the lower cap 904A from rotating about or moving along the circumference of the end 902A of the housing 902. In order to dispense a blade cartridge or assembly from the device 900, pressure or force is applied to either or both of the caps 904 and 904A to overcome such tension and to permit either or both of the caps 904 and 904A to rotate, as described above, to align the openings 910 and 910A for dispensing of a blade cartridge or assembly.

Still referring to FIG. 9, in one embodiment, the device 900 is constructed and arranged as described to store and to dispense the blade assembly 200 of the razor 100 as described above. Multiple blade assemblies 200 may be stored and dispensed from the device 900. Each blade assembly 200 is contained within one of the receptacles 903 such that the orifice 504 of the assembly 200 is disposed in facing relation to the underside of the caps 904 and 904A. Where the openings 910 and 910A of the caps 904 and 904A are in alignment to dispense the blade assembly 200, the orifice 504 of the assembly 200 is accessible through the openings 904 and 904A. The pin or rod 302 of the handle 300 may be inserted through the openings 904 and 904A and into and through the orifice 504. The pin or rod 302 of the handle 300 thereby connects to the interior configuration of the blade assembly 200 as described above and comes to rest in a locking position. The handle 300 may then withdraw the blade assembly 200 from the receptacle 903 via the locked position or engagement created by the locking notches of the pin or rod 302 and the locking tabs 708 and 709 of the interior configuration of the blade assembly 200.

In alternative configurations, the device may include only one of the caps 904 or 904A with a single one of the openings 910 or 910A, wherein the cap 904 or 904A is constructed and arranged to seal-off the end 902A of the device 900 and to operate similarly as described above.

The device 900 may be constructed of one or more materials including, but are not limited to, metal, metal alloys, plastic, ABS, polymers, synthetic rubber, polypropylene, other flexible materials, wood, ceramic, glass, and any combinations thereof.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

What is claimed is:

1. A razor comprising:
a razor blade assembly configured to mount and to contain one or more razor blades or razor blade cartridges;
a handle releasably attached to one end of the razor blade assembly that terminates the length of the razor blade assembly whereby the razor blade assembly is positioned at a substantially perpendicular orientation relative to the handle, such that, the razor blade assembly and the handle define an L-shaped profile;
a pin projecting from an upper portion of the handle and being constructed and arranged to engage with the razor blade assembly to attach the razor blade assembly to the handle; and
an orifice defined along the one end of the razor blade assembly, the pin being further constructed and arranged and the orifice being sized and configured such that the orifice receives at least a portion of the pin to attach the handle to the razor blade assembly.

2. A device for storing razor blade sets comprising:
a housing defining a chamber and one open terminal end, and including one or more dividing walls, each dividing wall radiating from a central point of the chamber to an inner surface of the housing and extending downward along at least a portion of the length of the housing;
the one or more dividing walls defining at least one storage receptacle within the chamber, the storage receptacle having dimensions such that the storage receptacle receives and contains a razor blade cartridge or assembly; and
a spring-loaded cap being sized and configured to attach to the open terminal end and defining an opening along an outer surface, the opening being sized and configured to permit dispensing of a razor blade cartridge or assembly from the storage receptacle through the opening.
